(19) United States
(12) Patent Application Publication
(10) Pub. No.: US 2011/0228079 A1
(43) Pub. Date: Sep. 22, 2011

(54) METHOD FOR THE SELECTIVE DISPLAY OF INFORMATION FROM A CAMERA SYSTEM IN A DISPLAY DEVICE OF A VEHICLE AND VEHICLE WITH A CAMERA SYSTEM

(75) Inventor: Holger WOLF, Essenheim (DE)

(73) Assignee: GM GLOBAL TECHNOLOGY OPERATIONS LLC, Detroit, MI (US)

(21) Appl. No.: 13/049,392

(22) Filed: Mar. 16, 2011

(30) Foreign Application Priority Data
Mar. 16, 2010 (DE) 102010011496.0

(51) Int. Cl. H04N 7/18

(52) U.S. Cl. 348/113; 348/E07.085

(57) ABSTRACT

A method is provided for the selective display of information from a camera system in a display device of a vehicle and vehicle with a camera system. The method includes, but is not limited to selecting an operating mode of the camera system, determining at least one quantity characterizing a possible reversing of the vehicle, and displaying information from at least one camera of the camera system in the display device as a function of the selected operating mode of the camera system if the at least one determined quantity characterizes an imminent reversing of the vehicle.

### CROSS-REFERENCE TO RELATED APPLICATION

This application claims priority to German Patent Application No. 102010011496.0, filed Mar. 16, 2010, which is incorporated herein by reference in its entirety.

### TECHNICAL FIELD

The technical field relates to a method for the selective display of information from a camera system in a display device of a vehicle and a vehicle with a camera system.

### BACKGROUND

Known from DE 10 2008 049 113 A1 are a method and a device for assisting a parking process by which means an improved and easy-to-operate parking system and a corresponding method are to be provided. For this purpose it is proposed to measure a parking space with distance-measuring sensors and to detect the surroundings of the parking space by a camera. A graphic representing the detected parking space is projected into the camera image. Likewise an actual travel path obtained from a current driver position of the motor vehicle and a desired travel path calculated for the parking process are projected into the camera image. The projections in the camera image are updated depending on the position of the motor vehicle.

It is at least one object to provide a method for the selective display of information from a camera system in a display device of a vehicle and a vehicle having a camera system that provides an increased degree of operating possibilities of the camera system. In addition, other objects, desirable features and characteristics will become apparent from the subsequent summary and detailed description, and the appended claims, taken in conjunction with the accompanying drawings and this background.

### SUMMARY

A method is provided for the selective display of information from a camera system in a display device of a vehicle. The method comprises selecting an operating mode of the camera system. In addition, determining at least one quantity characterizing a possible reversing of the vehicle, displaying information from at least one camera of the camera system in the display device as a function of the selected operating mode of the camera system if the at least one determined quantity characterizes an imminent reversing of the vehicle.

By selecting the operating mode of the camera system and displaying information from the at least one camera of the camera system as a function of the selected operating mode of the camera system, this embodiment of the method advantageously makes it possible to expand the operating possibilities of the camera system since no fully automatic display of the camera image takes place if the at least one determined quantity characterizes an imminent reversing of the vehicle. As a result, specific cases can be taken into account in which the display of information from the camera is not desired or is disadvantageous.

The vehicle is preferably a motor vehicle, such as an automobile or a truck.

In a further preferred embodiment of the method, the camera system comprises a first operating mode and a second operating mode, wherein in the second operating mode a display of information from the at least one camera of the camera system is omitted if a request for the display of the information from the at least one camera is not made by an occupant of the vehicle. Furthermore, a display of information from the at least one camera of the camera system is made in the second operating mode if the at least one determined quantity characterizes an imminent reversing of the vehicle and if a request for the display of the information from the at least one camera is made by an occupant of the vehicle.

In the first operating mode, an automatic display of information from the at least one camera of the camera system can be made if the at least one determined quantity characterizes an imminent reversing of the vehicle. The determined quantity is preferably an engagement of reverse gear of the vehicle.

The embodiments increase the user friendliness for the display of information from the camera system in the display device since the user, i.e., the occupant of the vehicle, can decide whether he always has the camera image display when reverse gear is engaged (in the first operating mode) or only in certain cases (in the second operating mode).

In a further embodiment, the display device is part of an information and entertainment system of the vehicle. Information and entertainment systems, also known as so-called “infotainment systems”, increasingly comprise corresponding display devices that are suitable for displaying camera images in a sufficient size and resolution, with the result that this embodiment can advantageously access components already present in the vehicle.

In a further embodiment, the operating mode of the camera system is selected by an occupant of the vehicle. The choice of operating mode can be made by means of a selection, in particular a manual or voice-controlled selection, of an entry from a menu with operating modes.

In a further embodiment, the selection of the operating mode of the camera system is made automatically. The second operating mode can then be selected if at least one warning message is output, in particular in the display device. The at least one warning message can be selected from the group consisting of a risk of black ice warning message, an aquaplaning warning message, a cooling water level warning message, an engine oil level warning message, a traffic jam message and a defect warning message, in particular a warning message relating to a defective lighting of the vehicle. Furthermore, the first operating mode can be selected if no warning message is output, in particular in the display device. These embodiments have the advantage that if a warning message is present, in particular in the display device, this can furthermore be output in the event of an imminent reversing and is not overwritten by a display of information from the at least one camera of the camera system in the display device or the occupant of the vehicle is distracted from the existing warning message by this display.

In a further embodiment, the request for the display of information is made by means of actuating a button. The button is preferably part of the information and entertainment system of the vehicle. For example, the button can be an information button or an information knob of the information and entertainment system. This has the advantage that a control button of the information and entertainment system already provided can be used.

A vehicle is also provided that comprises a camera system having at least one camera. Furthermore, the vehicle has a selection device configured to select an operating mode of the camera system and a determination device configured to determine at least one quantity characterizing a possible reversing of the vehicle. In addition, the vehicle has a display device configured to display information from the at least one camera of the camera system depending on the selected operating mode of the camera system if the at least one determined quantity characterizes an imminent reversing of the vehicle. The vehicle has the advantages already specified in connection with the first embodiment of the method, which are not listed again at this point to avoid repetitions. The camera is preferably disposed in a rearward region of the vehicle and in the rearward direction of the vehicle. Furthermore, the vehicle is preferably a motor vehicle, in particular an automobile or a truck.

### BRIEF DESCRIPTION OF THE DRAWINGS

The embodiments will hereinafter be described in conjunction with the following drawing figures, wherein like numerals denote like elements, and:

FIG. 1 shows a flow diagram of a method for the selective display of information from a camera system in a display device of a vehicle according to a first embodiment;

FIG. 2 shows a flow diagram of a method for the selective display of information from a camera system in a display device of a vehicle according to a second embodiment;

FIG. 3 shows a vehicle with a camera; and

FIG. 4 shows a camera system of the vehicle according to FIG. 3.

### DETAILED DESCRIPTION

The following detailed description is merely exemplary in nature and is not intended to limit the application and uses. Furthermore, there is no intention to be bound by any theory presented in the preceding background or summary or the following detailed description.

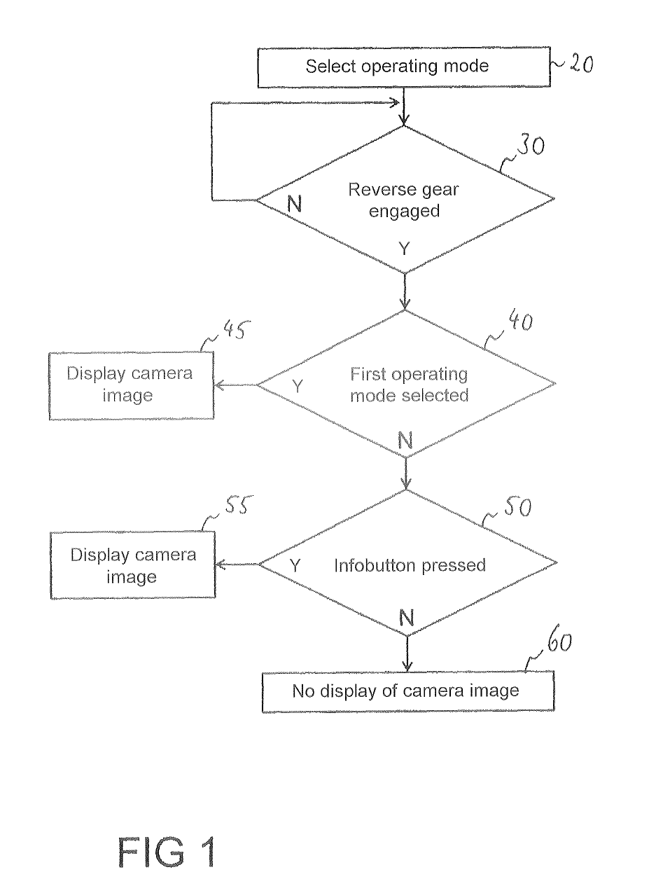

FIG. 1 shows a flow diagram of a method for the selective display of information from a camera system in a display device of a vehicle according to a first embodiment. To this end, a selection of an operating mode of the camera system is made in step 20. In the embodiment shown, the selection of the operating mode is made by an occupant of the vehicle, for example, by means of selecting an entry from a menu with operating modes.

In the embodiment shown the camera system has a first operating mode and a second operating mode. In the first operating mode, information from at least one camera of the camera system is displayed automatically as soon as a reverse gear of the vehicle is engaged. In the second case, information from the at least one camera of the camera system is displayed if the reverse gear is engaged and a request for the display of the information from the at least one camera is made by the occupants of the vehicle. A display of information from the at least one camera of the camera system is omitted in the second operating mode if a request for the display of the information from the at least one camera is not made by the occupants of the vehicle.

In step 30 it is determined whether the reverse gear of the vehicle is engaged. If reverse gear is not engaged, step 30 is carried out repeatedly. If reverse gear is engaged, in step 40 it is checked whether the first operating mode is selected. If the first operating mode is selected, in a step 45 the camera image is displayed in the display device of the vehicle. If the first operating mode is not selected, i.e. the second operating mode is selected, in a step 50 it is checked whether a request for the display of information from the at least one camera is made by the occupants of the vehicle. To this end, in the embodiment shown it is checked whether an information button or an information knob of an information and entertainment system of the vehicle is pressed or was pressed after engaging reverse gear. If the information button or information knob is or was pressed, in a step 55 the camera image is displayed in the display device of the vehicle. If the information button or information knob is or was not pressed, a display of the camera image in the display device is omitted, which is shown by a step 60.

In the embodiment shown the display device of the vehicle is part of the information and entertainment system of the vehicle, for example, in the form of a display of the information and entertainment system.

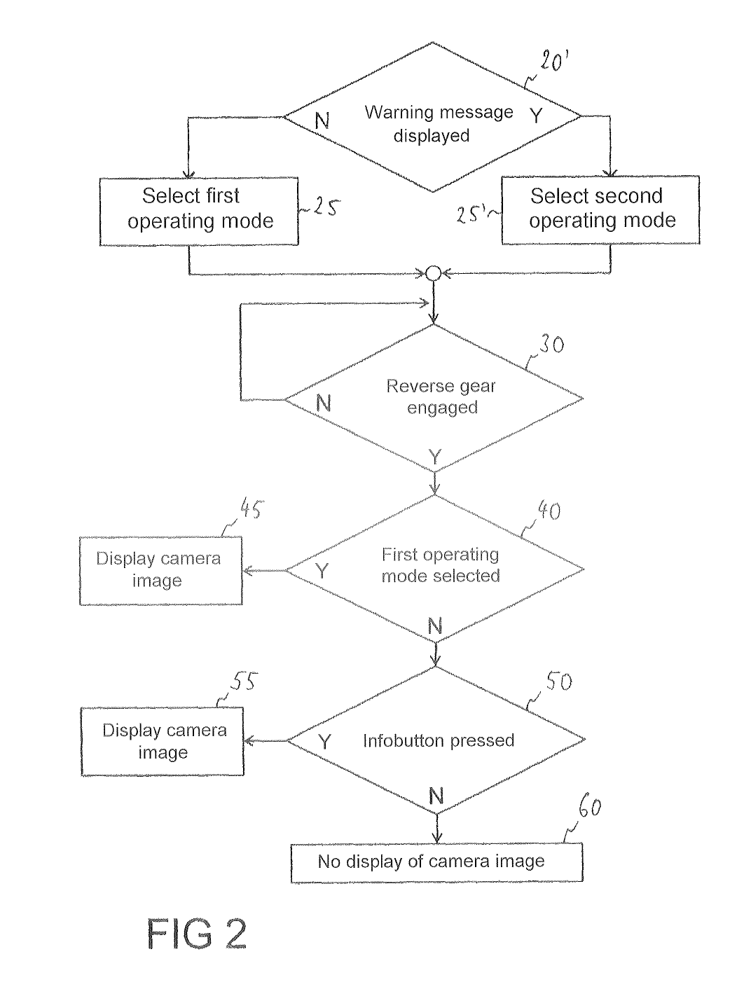

FIG. 2 shows a flow diagram of a method for the selective display of information from a camera system in a display device of a vehicle according to a second embodiment. Steps with the same functions as in FIG. 1 are identified with the same reference numbers and are not discussed again in the following.

In the embodiment shown a selection of the operating mode of the camera system is made automatically. To this end it is determined in a step 20′ whether at least one warning message is output, in particular in the display device. The at least one warning message is in this case preferably selected from the group consisting of a risk of black ice warning message, an aquaplaning warning message, a cooling water level warning message, an engine oil level warning message, a traffic jam message and a defect warning message, in particular a warning message relating to a defective lighting of the vehicle. If no warning message is output, in a step 25 a selection of the first operating mode is made. If, on the other hand, a warning message is displayed, in particular in the display device, in a step 25′ a selection of the second operating mode is made. The further steps of the method are steps 30 to 60 shown in FIG. 1 and are not listed again at this point to avoid repetitions.

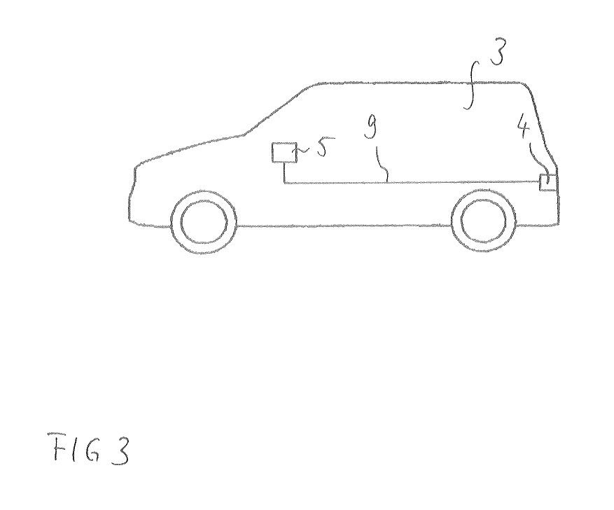

FIG. 3 shows a vehicle 3 with a camera 4. In the embodiment shown, the vehicle 3 is a motor vehicle in the form an automobile. The camera 4 is disposed in a rearward region of the vehicle 3 and in the rearward direction of the vehicle 3 and forms a reversing camera of the vehicle 3. In addition to the camera 4, the vehicle 3 can have further cameras, which for example are disposed in a sideward direction of the vehicle 3. The camera 4 is part of a camera system of the vehicle 3 not shown in detail, as is further explained in connection with the following figures. The camera 4 is connected via a connecting line 9 to an information and entertainment system 5 of the vehicle 3. The connecting line 9 can be implemented at least in part with the aid of a CAN bus of the vehicle 3.

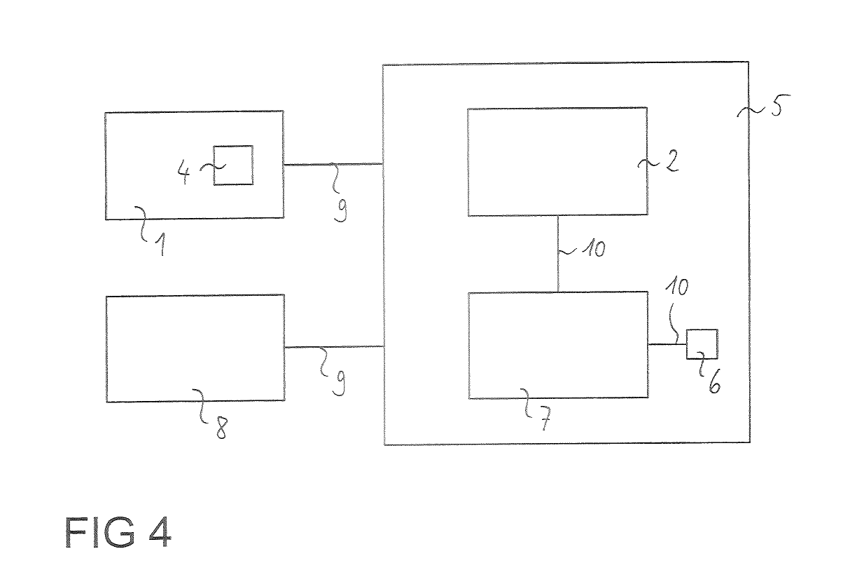

FIG. 4 shows a camera system 1 of the vehicle according to FIG. 3 which includes the camera 4. Components having the same functions as in FIG. 3 are identified with the same reference numbers and are not discussed again in the following. The camera system 1 is connected via a connecting line 9 to the information and entertainment system 5 of the vehicle. The information and entertainment system 5 is in turn connected via a connecting line 9 to a determination device 8. The connecting lines 9 can be implemented at least in part with the aid of a CAN bus of the vehicle. The determination device 8 is configured to determine at least one quantity characterizing a possible reversing of the vehicle, for example, to determine whether a reverse gear of the vehicle has been engaged.

The information and entertainment system 5 comprises a display device 2 and a selection device 7. The selection device 7 is configured to select an operating mode of the camera system 1. To this end, the selection device 7 for example has a menu with operating modes from which an occupant of the vehicle can select an entry for selecting the operating mode. The menu with operating modes can, for example, be displayed in the display device 2. Furthermore, the selection device 7 can automatically perform the selection of the operating mode of the camera system 1. The selection as to whether the operating mode should be carried out by the occupant of the vehicle or automatically, can also be made by the occupant of the vehicle, in particular by means of selecting an entry from the menu, wherein the menu can in turn be displayed in the display device 2.

In the embodiment shown, the camera system 1 has a first operating mode and a second operating mode, wherein in the first operating mode a display of information from the at least one camera 4 of the camera system 1 takes place automatically if the at least one quantity determined by the determination device 8 identifies an imminent reversing of the vehicle.

In the second operating mode, information from the at least one camera 4 of the camera system 1 is displayed if the at least one determined quantity characterizes an imminent reversing of the vehicle and if a request for the display of information from the at least one camera 4 is made by occupants of the vehicle. The display of information from the at least one camera 4 of the camera system 1 is omitted in the second operating mode if a request for the display of the information from the at least one camera 4 by the occupants of the vehicle is omitted. To this end, the information and entertainment system 5 has a button 6 which, for example, is an information button of the information and entertainment system 5. The request for the display of information is made by actuating the button 6. To this end, the button 6 is connected via a connecting line 10 to the selection device 7 and the selection device 7 is connected to the display device 2 via a further connecting line 10.

The display device 2 is therefore configured to display information from the at least one camera 4 of the camera system 1 as a function of the selected operating mode of the camera system 1 if the at least one determined quantity characterizes an imminent reversing of the vehicle.

The method starts from the consideration that the fully automatic switching-on of the reversing camera image as soon as reverse gear is engaged may not be desired by the vehicle user in certain cases. The method provides via the information and entertainment system of the vehicle a man-machine interface menu for occupants of the vehicle, by which means an automatic display of the reversing camera image upon engaging reverse gear can be activated or deactivated. In one embodiment, in the activated state the images recorded by the reversing camera are displayed on the infotainment display as soon as reverse gear is engaged. In the deactivated state the images recorded by the reversing camera are only displayed if the user of the vehicle presses a special knob or a special button which is provided by one of the infotainment control buttons, for example an information knob, while reverse gear is engaged. The method preferably does not overwrite any other menu in the reverse gear mode, which is of importance for the occupants of the vehicle, for example, navigation route information.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for a selective display of information from a camera system in a display device of a vehicle, comprising:
selecting an operating mode of the camera system;
determining at least one quantity that characterizes a possible reversing of the vehicle; and
displaying information from at least one camera in the display device as a function of the operating mode of the camera system if the at least one quantity characterizes a reversing of the vehicle.

2. The method according to claim 1, wherein the camera system comprises a first operating mode and a second operating mode, the method further comprising:
omitting display of information from the at least one camera in the second operating mode if a request for a display of the information from the at least one camera is not made by an occupant of the vehicle.

3. The method according to claim 2, further comprising:
displaying information from the at least one camera in the second operating mode if the at least one quantity characterizes an imminent reversing of the vehicle and if the request for the display of the information from the at least one camera is made by the occupant of the vehicle.

4. The method according to claim 2, displaying information from the at least one camera in the first operating mode if the at least one quantity characterizes an imminent reversing of the vehicle.

5. The method according to claim 1, wherein the quantity is an engagement of a reverse gear of the vehicle.

6. The method according to claim 1, wherein the display device is part of an information and entertainment system of the vehicle.

7. The method according to claim 1, further comprising receiving a selection of the operating mode from an occupant of the vehicle.

8. The method according to claim 7, wherein the receiving the selection of the operating mode is received an entry from a menu with a plurality of operating modes.

9. The method according to claim 2, further comprising selecting the second operating mode if at least one warning message is received.

10. The method according to claim 9, wherein the at least one warning message is a black ice warning message.

11. The method according to claim 9, wherein the at least one warning message is an engine oil level warning message.

12. The method according to claim 9, wherein the first operating mode is selected if the at least one warning message is not received.

13. A vehicle comprising:
at least one camera;
a selection device configured to select an operating mode of the at least one camera;
a determination device configured to determine at least one quantity characterizing a possible reversing of the vehicle; and
a display device configured to display information from the at least one camera depending on the operating mode of the at least one camera if the at least one quantity characterizes a reversing of the vehicle.

14. The vehicle according to claim 13, wherein the at least one camera comprises a first operating mode and a second operating mode, the display of information from the at least one camera in the second operating mode is omitted if a request for the display of the information from the at least one camera is not made by an occupant of the vehicle.

15. The vehicle according to claim 14, wherein the display device is further configured to display information from the at least one camera in the second operating mode if the at least one quantity characterizes an imminent reversing of the vehicle and if the request for the display of the information from the at least one camera is made by the occupant of the vehicle.

16. The vehicle according to claim 14, wherein the display device is further configured to display information from the at least one camera in the first operating mode if the at least one quantity characterizes an imminent reversing of the vehicle.

17. The vehicle according to claim 13, wherein the quantity is an engagement of a reverse gear of the vehicle.

18. The vehicle according to claim 14, wherein the second operating mode is selected if at least one warning message is received.

19. The vehicle according to claim 18, wherein the at least one warning message is a black ice warning message.

20. The vehicle according to claim 13, wherein the display device is part of an information and entertainment system of the vehicle.
